(19) United States
(12) Patent Application Publication
(10) Pub. No.: US 2014/0278461 A1
(43) Pub. Date: Sep. 18, 2014

(54) SYSTEM AND METHOD FOR INTEGRATING A MEDICAL SEQUENCING APPARATUS AND LABORATORY SYSTEM INTO A MEDICAL FACILITY

(71) Applicant: Memorial Sloan-Kettering Cancer Center, New York, NY (US)

(72) Inventor: David R. Artz, Scotch Plains, NJ (US)

(21) Appl. No.: 13/834,821

(22) Filed: Mar. 15, 2013

(51) Int. Cl. G06Q 50/22; G06Q 10/06

(52) U.S. Cl. CPC G06Q 50/22; G06Q 10/06314
USPC 705/2

(57) ABSTRACT

A method may include accessing an order including a request for analysis by high throughput sequencer apparatus, where the order is associated with a biological sample identifier and a patient identifier, and scheduling, for processing with the sequencer apparatus, the request. The method may include determining availability of result information, including raw data generated by the sequencer apparatus, and assembling the raw data into aligned data, where assembling includes aligning the raw data against one or more references. The method may include analyzing the aligned data with respect to information identified by the request, and providing the raw data and/or the aligned data for long term storage. The method may include formatting a report for review by a medical professional, including information derived through analyzing the aligned data, and providing information associated with the report to a separate medical facility computing device for association with the patient identifier.

### BACKGROUND

Medical sequencing is a new approach to discovery of the genetic causes of complex disorders. Medical sequencing refers to the brute-force sequencing of the genome or transcriptome of individuals affected by a disease or with a trait of interest. Dissection of the cause of common, complex traits is anticipated to have an immense impact on the biotechnology, pharmaceutical, diagnostics, healthcare and agricultural biotech industries. Sequencing of nucleic acids, such as deoxyribonucleic acid (DNA) and ribonucleic acid (RNA), involves determining the order of the nucleotide bases, namely adenine, guanine, cytosine, uracil, and thymine contained within a genetic sample (e.g., DNA from a blood sample). Various depths of information may be derived depending upon the type of sequencing performed. For example, traditional Sanger sequencing approaches typically involve the sequencing of small portions of DNA and/or RNA, while Next Generation Sequencing (NGS) approaches can be used to sequence much larger sequences, with substantially higher throughput. Medical sequencing has been made possible by the development of transformational, next generation DNA sequencing instruments, developed by 454 Life Sciences/Roche Diagnostics, Applied Biosystems/Agencourt, Illumina/Solexa and Helicos. Advantages of NGS technologies include the ability to produce an enormous volume of data cheaply, in some cases in excess of a hundred million short sequence reads per instrument run.

Medical sequencing data obtained through an NGS approach might cover one or more fields of study in the life sciences ending in “-omics” or “ome” (-omics or -ome referring to a totality or entirety of study) including, but not limited to one or more genome(s) (also referred to as full genome sequencing (FGS)) transcriptome(s) (i.e., RNA molecules of a particular organism including one or more of mRNA, rRNA and/or tRNA), microRNAome (i.e., small non-coding RNA (ncRNA), including but not limited to microRNAs (miRNA)), proteome (i.e. entire set of expressed proteins), epigenome (i.e., chemical changes to the DNA and chromatin structure), metabolome (i.e. small metabolite profiles), and/or combinations thereof.

In some embodiments, an NGS approach is applied to a genome. In some embodiments a genome comprises the entirety of an organism's hereditary information. In some embodiments, hereditary information is encoded as DNA, the entirety of which is referred to as a DNA genome. In some embodiments, a genome includes, but is not limited to genes (stretches of DNA/RNA that encodes a polypeptide), non-coding sequences of DNA or RNA (stretches of DNA/RNA that don't encodes a polypeptide). In some embodiments, a genome comprises an exome. The exome is part of the genome formed by exons, the sequences which when transcribed remain within the mature RNA after introns are removed by RNA splicing. Exomes differ from transcriptomes in that an exome consists of all DNA that is transcribed into mature RNA in cells of any type at any time.

In some embodiments, an NGS approach is applied to a transcriptome. In some embodiments, a transcriptome comprises all sets of RNA molecules (i.e. messenger RNA (mRNA), ribosomal RNA (rRNA), transfer RNA (tRNA), non-coding RNA (ncRNA)) expressed in a single population of cells at a given time. Transcriptomes differ from exomes in that transcriptomes include only those RNA molecules found in a specified cell population, and typically include the relative level of each RNA molecule. In some embodiments, a transcriptome comprises mRNA (mRNA is transcribed into a polypeptide by the ribosome). In some embodiments, a transcriptome comprises rRNA (rRNA is the central component of the ribosome's protein-manufacturing machinery). In some embodiments, a transcriptome comprises tRNA (tRNA mediates recognition of the codon and provides the corresponding amino acid). In some embodiments, a transcriptome comprises non-coding RNA (ncRNA) (functional RNA molecule that is not translated into a polypeptide). A transcriptome consisting of ncRNA is referred to as a ncRNAome. A ncRNAome consisting primarily of microRNAs (miRNA) (a class of small noncoding RNAs that have important regulatory roles in multicellular organisms) is referred to as a miRNAome. Whole transcriptome amplification (WTA) can be a valuable technique for amplification of a transcriptome from minimal or limiting amounts of nucleic acids for subsequent molecular genetic analysis. Following a reverse transcription step, whole transcriptome amplification can involve either conventional or nonconventional PCR amplification methods. Conventional PCR entails the amplification and subsequent detection of specific DNA sequences that are precisely characterized in length and sequence using nondegenerate primers, while random, “non-conventional” PCR involves universal amplification of prevailing DNA or amplification of unknown intervening sequences which are not generally defined in length or sequence using degenerate primers.

In some embodiments, an NGS approach is applied to a proteome. Proteomics is often considered the next step in the study of biological systems, after genomics. The challenge of unraveling the proteome is generally considered much more complicated than genomics, primarily because the proteome differs from cell to cell and constantly changes through biochemical interactions with the genome and the environment. An organism has radically different protein expression in different parts of its body, different stages of its life cycle and different environmental conditions. Another major difficulty is the complexity of proteins relative to nucleic acids; in humans there are about 25,000 identified genes but an estimated 500,000 proteins derived from these genes. This increased complexity derives from mechanisms such as alternative splicing, protein modification (glycosylation, phosphorylation) and protein degradation. The level of transcription of a gene gives only a rough estimate of its level of expression into a protein. An mRNA produced in abundance may be degraded rapidly or translated inefficiently, resulting in a small amount of protein. Additionally, many proteins experience post-translational modifications that profoundly affect their activities; for example some proteins are not active until they become phosphorylated. Methods such as phosphoproteomics and glycoproteomics are used to study post-translational modifications. Many transcripts also give rise to more than one protein through alternative splicing or alternative post-translational modifications. Finally, many proteins form complexes with other proteins or RNA molecules, and only function in the presence of these other molecule.

In some embodiments, a proteome comprises the entire set of expressed proteins in a given type of cell, tissue, organism, or genome at a given time under defined conditions. In some embodiments, a proteome comprises a collection of proteins found in a particular cell type under a particular set of environmental conditions (e.g. exposure to hormone stimulation), referred to as a cellular proteome. In some embodiments, a proteome comprises a complete set of proteins from all of the various cellular proteomes of an organism (i.e. an organisms complete proteome). In some embodiments, a proteome comprises a collection of proteins in sub-cellular biological systems (e.g. all the proteins in a virus are referred to as a viral proteome).

In some embodiments, an NGS approach is applied to an epigenome. Changes to the epigenome can result in changes to the structure of chromatin and changes to the function of the genome. In some embodiments, and epigenome comprises a record of the chemical changes to DNA and histone proteins of an organism. In some embodiments, the chemical changes to DNA and histone proteins can be passed down to an organism's offspring. Some of the cytosine residues in all vertebrate genomes are methylated, producing what amounts to a fifth DNA base, 5-methylcytosine. Methylation has been shown to regulate gene expression, and hence alter cellular state. Differentiation and development of genetically identical cells seems to be controlled by a combination of signaling and epigenetic effects, including DNA methylation state. In addition, several types of disease have shown a direct dependence on methylated state, e.g. colorectal or breast cancer. The importance of DNA methylation in disease state, cellular control, growth and differentiation is known in the art. Often times in cancer, tumors undergo a major disruption of DNA methylation and histone modification patterns, which are reflected in the epigenome. In some embodiments, the epigenome of a cancer cell is characterized by a global genomic hypomethylation, CpG island promoter hypermethylation of tumor suppressor genes, altered histone code, loss of monoacetylated and trimethylated histone H4, and/or combinations thereof.

In some embodiments, an NGS approach is applied to a metabolome (i.e. the complete set of metabolites found in a biological sample, especially found in an organism under normal conditions, and when suffering from a disease). Metabolites are the end products of cellular processes and metabolic profiling can provide an instant snapshot of the physiology of one or more cells. In some embodiments, a metabolome comprises set of small-molecule metabolites, such as metabolic intermediates, hormones and other signaling molecules, and secondary metabolites, to be found within a biological sample (e.g. tumor sample).

First generation sequencing apparatus use a chain-terminator method (i.e. Sanger sequencing) based on the selective incorporation of chain-terminating dideoxynucleotides (dNTPs) during in vitro DNA replication. Common problems with the chain-terminator method include poor quality sequence reads in the first 15-40 bases, deteriorating sequence reads after 700-900 bases, low throughput (˜60-650 kb/hr) and high cost for larger sequencing projects. Next generation sequencing apparatus use a variety of techniques to allow for massive parallelization of the sequencing process, thus producing thousands or millions of sequences at once for relatively low cost. Many of these NGS approaches are commonly referred to as sequencing-by-synthesis (SBS), which does not clearly delineate the different mechanics of sequencing DNA (Metzker ML, Genome Res. (12):1767-76 (2005), which is incorporated herein by reference).

Next generation sequencing methods include but are not limited to, single-molecule real-time sequencing (SMRT)(Pacific Bio), ion semiconductor (Ion Torrent sequencing), pyrosequencing (Roche 454), sequencing by synthesis (Illumina Solexa), and sequencing by ligation (SOLiD sequencing).

In some embodiments, next generation sequencing apparatus use a “sequencing by synthesis” method which is based on the detection of pyrophosphate release on nucleotide incorporation (rather than chain termination as in the Sanger method). DNA sequence is determined by light intensity emitted upon incorporation of the next complementary nucleotide (only one of four dNTPs are added and available at a time). The previous nucleotide is degraded before the next dNTP is added for synthesis; the process is repeated with each of the four dNTPs until the DNA sequence of the single stranded DNA template is determined. In some embodiments sequencing by synthesis methods may use reversible dye-terminator dye technology (reversible terminator bases; RT-bases) rather than dNTPs, where the RT-bases are added and non-incorporated nucleotides are washed away. RT-bases comprise a dye along with a terminal 3′ blocker. A camera records an image of the fluorescently labeled nucleotides, and then the RT-base is chemically removed from the DNA, allowing the next cycle. Heliscope single molecule sequencing uses DNA fragments with added poly-A tail adapters which are anchored to a flow cell surface and nucleotides are added one type at a time (like the Sanger method) and use extension-based sequencing. Next generation sequencing by synthesis methods include massively parallel signature sequencing (MPSS), pyrosequencing, Illumina sequencing, Heliscope single molecule sequencing, and single molecule real time (SMRT) sequencing.

In some embodiments, next generation sequencing apparatus use a “sequencing by ligation” method which is based on using the enzyme DNA ligase to identify the nucleotide present at a given position in a DNA sequence. Sequencing by ligation relies upon the sensitivity of DNA ligase for base-pairing mismatches and has very low efficiency when there are mismatches between the bases of the two strands. Target DNA (to be sequenced) is typically anchored to a known sequence (via a short “anchor” strand of DNA). A pool of all possible oligonucleotides of a fixed length are labeled (typically with fluorescent dyes) according to the position that will be sequenced. The labeled probes are added, which bind to the target DNA sequence, next to the anchor sequence, and the DNA ligase preferentially joins the molecule to the anchor when its bases match the unknown DNA sequence. The fluorescence produced determines the identity of the nucleotide at this position in the target sequence. Next generation sequencing by ligation methods include polony sequencing, DNA nanoball sequencing (combines rolling circle replication to amplify small fragments of genomic DNA into DNA nanoballs, followed by unchained sequencing by ligation to determine sequence) and SOLiD sequencing.

Both sequencing by synthesis and sequencing by ligation methodologies typically comprise optical detection systems for reading out nucleotide identity. In some embodiments, next generation sequencing apparatus use a semiconductor based detection system (e.g. Ion semiconductor sequencing). Ion semiconductor sequencing is based on the detection of hydrogen ions that are released during polymerization of DNA. Typically, target DNA is flooded with a single type of nucleotide. Incorporation of a complementary nucleotide results in a release of a hydrogen ion that triggers a hypersensitive ion sensor.

In some embodiments, next generation sequencing apparatus may use nanopore sequencing, sequencing with mass spectrometry, microfluidic sanger sequencing, various microscopy-based techniques, RNA polymerase (RNAP) sequencing, and/or combinations thereof. In some embodiments, nanopore sequencing is based on the readout of electrical signals occurring at nucelotides passing by pores (e.g. alpha-hemolysin pore) covalently bound with cyclodextrin, where the change in ion current is dependent on the shape, size and length of the DNA sequence. In some embodiments, mass spectrometry may be used to determine DNA sequence.

High throughput sequencing apparatus involves time consuming processing which generates large quantities of data (e.g., around at least two to three gigabytes of data per sequencing order). The price of sequencing apparatus, high speed processor computing devices, and big data storage has all dropped in recent years. This reduction in price for what initially had been a cost-prohibitive venture for a single medical facility has paved the way for introducing high throughput sequencing apparatus into the medical facility environment.

A need exists for a Clinical Sequencing Information System configured to communicate with the integrated laboratory environments of a large medical facility, such as a hospital or specialized surgical care facility. For example, cancer treatment and research may benefit by enabling high throughput sequencing apparatus test orders within the clinical environment, combining outcome data with other known patient data. A Clinical Sequencing Information System developed for a medical facility environment can be designed to achieve compliance with regulatory and certification requirements, such as HIPAA, while providing specialized and timely reports related to patient care. The system, additionally, would provide the benefit of long term retention of sequencing data associated with a patient, in the same manner as digital images of X-ray and other scanning apparatus are presently retained.

### SUMMARY

A Clinical Sequencing Information System designed for interoperability with a medical facility integrated computing system environment includes high throughput sequencer apparatus, order coordination processes for accepting, fulfilling, and completing orders placed by an external department of the medical facility computing system, workflow management processes for management of fulfillment of orders, and security and privacy processes for ensuring patient privacy in relation to data obtained in relation to order fulfillment. The Clinical Sequencing Information System may communicate with the medical facility integrated computing system, for example, using a common messaging standard, such as the Health Level Seven (HL7) Standard developed by HL7, headquartered in Ann Arbor, Mich. The Clinical Sequencing Information System may include a wet lab portion for obtaining and preparing a biological sample, one or more high throughput sequencers for sequencing a prepared (e.g., DNA extracted, etc.) biological sample, and a processing system for applying post-sequencing processes (e.g., reformatting to a standardized format, alignment, post-alignment report analysis, report generation, etc.) to the sequence data. In the process of fulfilling an order, data generated by the Clinical Sequencing Information System, such as raw sequence data, aligned data, medical professional annotations, and diagnostic (e.g., report) data may be retained in long term storage for association with a particular patient identifier. Report data generated by the Clinical Sequencing Information System, for example, may be customized on a per-order basis. In some examples, report data may be customized based upon audience (e.g., pathologist, clinician, etc.), testing requests (e.g., diagnosis confirmation, treatment regimen recommendations, etc.) and/or patient record information (e.g., results and analysis related to other medical facility departments such as, in some examples, pathology, mammography, cardiology, endoscopy, and radiology).

In one aspect, the present disclosure relates to a method including accessing, by a processor of a computing device of a medical facility, an order including a request for analysis by high throughput sequencer apparatus, where the order is associated with a biological sample identifier and a patient identifier and scheduling, by the processor, for processing with the high throughput sequencer apparatus, the request. The method may include determining, by the processor, availability of result information responsive to the processing, where the result information includes raw data generated by the high throughput sequencer apparatus and assembling, by the processor, the raw data into aligned data, where assembling includes aligning the raw data against one or more references. The method may include analyzing the aligned data with respect to information identified by the request for analysis, and providing at least one of the raw data and the aligned data for long term storage. The method may include formatting a report for review by a medical professional, where the report includes information derived from the aligned data through analyzing the aligned data, and providing, by the processor, information associated with the report to a separate medical facility computing device for association with the patient identifier.

In some embodiments, the order includes an indication of at least one of a) a tumor site and b) one or more test panels. The one or more references may include at least one of biological structure information and biological sequence information. A first reference of the one or more references may include one of a genome, a microRNAome, a ncRNAome, a transcriptome, a proteome, an epigenome and a metabolome.

In some embodiments, the high throughput sequencer apparatus includes a next generation sequencer. The high throughput sequencer apparatus may generate, by a processor of sequencer computing device, multiple, fragmented sequence reads. The high-throughput sequencer apparatus may be configured to perform at least one technique selected from the group consisting of single-molecule real-time sequencing (e.g., Pacific Bio), ion semiconductor sequencing (e.g., Ion Torrent sequencing), pyrosequencing (e.g., 454), sequencing by synthesis (e.g., Illumina), sequencing by ligation (e.g., SOLiD sequencing), and chain termination sequencing (e.g., Sanger sequencing).

In some embodiments, the raw data is formatted as FASTQ data. The method may include, prior to aligning the raw data, formatting the raw data in FASTQ format. The method may include, after assembling the raw data, updating an order status regarding availability of the aligned data. Updating the order status may include issuing a message to a medical facility interface system. The message may be formatted in HL7.

In some embodiments, assembling the raw data may include identifying differences between the raw data and the one or more references. The differences may include at least one of a single nucleotide polymorphism (SNP) and a mutation. The method may include storing the differences as a VCF file. The assembling may include accessing the one or more references stored in one or more target files, accessing the raw data as a sequence file, applying the one or more target files to the sequence file to generate the aligned data as an aligned sequence file, generating a variant file including information regarding differences between the sequence file and the one or more target files, and generating at least one log file including audit information regarding the assembly process.

In some embodiments, the method includes associating one or more annotations with the aligned data. The one or more annotations may be entered by an operator via a sequence alignment data viewing tool. The sequence alignment data viewing tool may include one of a Sequence Alignment/Map (SAM) file viewer, a Binary SAM (BAM) file viewer, a Gap4 sequence assembly viewer, and a Gap5 sequence assembly viewer. Formatting the report may include including information regarding the one or more annotations within the report.

In some embodiments, analyzing the aligned data with respect to information identified by the request includes analyzing the aligned data with respect to one or more of the following: a) one more identified genes, b) one or more identified single nucleotide polymorphisms, and c) one or more mutations. Analyzing the aligned data may include identifying one or more treatment regimens. The one or more treatment regimens may include at least one of a therapy, a combination of therapies, a medication, and a dosing schedule. Formatting the report may include including, within the report, the one or more treatment regimens. Formatting the report may include merging annotations into the report.

In some embodiments, the report includes information for referring clinicians. The report may include a diagnostic report. The method may include applying one or more access controls to the report. A first access control of the one or more access controls may include a user access level.

In some embodiments, the method includes, after determining availability of the result information, issuing, to a billing system of the medical facility, a billing notification. Providing at least one of the raw data and the aligned data for long term storage may include entering information into a data warehouse system for future data mining for research purposes. Providing the at least one of the raw data and the aligned data for long term storage may include encrypting information. Providing the at least one of the raw data and the aligned data for long term storage may include securing the at least one of the raw data and the aligned data. Securing the at least one of the raw data and the aligned data may include ensuring compliance with patient privacy guidelines. Assembling the raw data into the aligned data may include processing two or more portions of the raw data in parallel.

In one aspect, the present disclosure relates to a sequencing laboratory system including a high throughput sequencer apparatus, and a computing system including a processor and a memory having instructions stored thereon, where the instructions, when executed by the processor, cause the processor to access an order including a request for analysis by the high throughput sequencer apparatus, where the order is associated with a biological sample identifier, schedule, for processing with the high throughput sequencer apparatus, the request, and determine availability of result information responsive to the processing, where the result information includes raw data produced by the high throughput sequencer apparatus. The instructions, when executed, may cause the processor to assemble the raw data into aligned data, where assembling includes aligning the raw data with one or more references. The instructions, when executed, may cause the processor to analyze the aligned data, where analyzing the aligned data generates result information identifying differences between the raw data and the one or more references. Responsive to completion of analyzing the aligned data, the instructions, when executed, may cause the processor to issue an alert to a medical facility registration system regarding completion of the order. The instructions, when executed, may cause the processor to provide at least one of the raw data and the aligned data for storage in a data archive.

In some embodiments, the instructions when executed cause the processor to, prior to scheduling the request, determine availability of a biological sample associated with the biological sample identifier. The instructions when executed may cause the processor to archive information regarding at least one of assembling the raw data into aligned data and analyzing the aligned data. The instructions, when executed, may cause the processor to format, for review on a display of a user computing device, report data including at least a portion of the result information. Formatting the report may include applying one or more rule sets to the aligned data to identify one or more treatment regimens correlated with the differences identified in the input data. The treatment regimens may include one or more of drug sensitivities, drug combinations, dosing regimens, combination therapies. The rule sets may include one or more of the following: a) one or more mutations, b) one or more SNPs, and c) one or more polymorphisms.

In some embodiments, the sequencing laboratory system includes a second high throughput sequencer apparatus, where scheduling the request includes identifying the high throughput sequencer apparatus for processing of the request. The high throughput sequencer apparatus may be identified based at least in part upon one or more test panels associated with the request. Analyzing the aligned data may include distributing the aligned data to two or more processors for parallel analysis. Scheduling the request may include determining at least one of a priority level and a deadline associated with the request. Scheduling the request may include preempting, based at least in part on the at least one of the priority level and the deadline, a preexisting request.

In one aspect, the present disclosure relates to a non-transitory computer readable medium having instructions stored thereon, where the instructions, when executed by a processor, cause the processor to receive, via a medical facility system, a request for analysis by a high throughput sequencer apparatus, where the request includes a patient identifier. The instructions, when executed, may cause the processor to determine registration of delivery of a biological sample associated with the patient identifier, and, responsive to registration of delivery of the biological sample, schedule preparation of the biological sample for processing with the high throughput sequencer apparatus. The instructions, when executed, may cause the processor to receive acknowledgement of completion of preparation of the biological sample, and, responsive to the acknowledgement of completion of preparation of the biological sample, schedule, for processing with the high throughput sequencer apparatus, the request. The instructions, when executed, may cause the processor to determine availability of result information responsive to the processing, where the result information includes raw data produced by the high throughput sequencer apparatus, analyze the result information to obtain analysis data; responsive to completion of analysis, issue a notification to the medical facility system regarding completion of the request, where the notification includes the patient identifier, and store, for archival purposes, at least one of the raw data and the analysis data.

In some embodiments, the biological sample includes a tissue sample, and the instructions, when executed, cause the processor to, after scheduling the request, receive a failure indication associated with rejection of the biological sample, issue, for review by an operator, responsive to the failure indication, a request for a replacement biological sample, receive indication of availability of the replacement biological sample, and reschedule, for processing with the high throughput sequencer apparatus, the request.

In some embodiments, the indication of availability is provided by an operator, where the operator has an access level of one of a lab technologist access level and a pathologist access level. The instructions, when executed, may cause the processor to secure report information associated with the analysis data for presentation to operators having one or more authorized access levels. The one or more authorized access levels may include a pathologist access level. The instructions, when executed, may cause the processor to request user identification associated with the report information, receive user identification information associated with an operator, based at least in part upon the user identification information, verify authorization of the operator to review the report information; and, responsive to verification, provide the report information for review by the operator at a display device. Receiving user identification information may include receiving information obtained from a personnel identification card.

In some embodiments, receiving the request includes receiving the request associated with an operator authorized to submit requests for analysis. Receiving the request may include receiving at least one of identification of a tumor site and histology.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a diagram of an example medical facility system including an integrated sequencing laboratory system;

FIG. 2 is a flow diagram of an example workflow for processing an order in a sequencing laboratory system;

FIG. 3 is a block diagram of an example medical facility system and example communications integration via a central facility interface;

FIG. 4 is a flow diagram of example workflow stages for processing orders in a sequencing laboratory system;

FIG. 5 is a process diagram of an example sequencing laboratory system process flow;

FIG. 6 is a flow chart of an example method for processing orders within an integrated sequencing laboratory system;

FIG. 7 is a block diagram of an example network environment for integrating a sequencing apparatus and sequencing laboratory system into a medical facility; and

FIG. 8 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, the present disclosure may be directed to one or more systems, methods, and apparatus for integrating a Clinical Sequencing Information System with a medical facility computing system environment. The Clinical Sequencing Information System, for example, can coordinate activities involving order acceptance, fulfillment, and completion of tests involving obtaining data from high throughput sequencer apparatus, In some implementations, orders are placed by an external department of the medical facility computing system, and the Clinical Sequencing Information System manages workflow processes for order fulfillment, as well as security and privacy processes for ensuring patient privacy in relation to data obtained in relation to order fulfillment. The Clinical Sequencing Information System may communicate with the medical facility computing system, for example, using a common messaging standard, such as the Health Level Seven (HL7) Standard developed by HL7, headquartered in Ann Arbor, Mich. The Clinical Sequencing Information System may function as part of a Sequencing Lab System including a wet lab portion for obtaining and preparing a biological sample, one or more high throughput sequencers for sequencing a prepared (e.g., DNA extracted, etc.) biological sample, a processing system for applying post-sequencing processes (e.g., reformatting to a standardized format, alignment, post-alignment report analysis, report generation, etc.) to the sequence data, and a retention system for retaining data related to the order fulfillment.

Turning to FIG. 1, a system diagram of an example medical facility system 100 including an integrated sequencing laboratory system 102 for providing an integrated, automated high throughput (e.g., next generation) sequencing system to the medical facility system 100. The medical facility system 100, for example, may include a hospital, clinic, research center, university hospital facility, or other medical facility incorporating a number of autonomous laboratory and information systems such as, in some examples, a records system 104, a pathology system 106, and a registration system 108. The autonomous systems 102, 104, 106, and 108 are configured to exchange information via a facility interface engine 110. A more detailed example of an integrated medical facility system is described in relation to FIG. 3.

The sequencing laboratory system 102 includes a clinical sequencing information system (CSIS) 112 that coordinates the order fulfillment, scheduling and other workflow management, analysis, as well as the data retention related to genomic sequencing orders. The CSIS 112 interfaces with high throughput sequencing apparatus, such as a medical sequencer 114, to obtain raw data 116 for analysis and interpretation. Although illustrated as a single computing device, the CSIS 112, in some implementations, is distributed across a number of computing devices within the sequencing laboratory system 102. In some implementations, and one or more portions of the CSIS 112 may be distributed via a network to other laboratory and/or information systems within the medical facility system 100. At least a portion of the processing attributed to the CSIS 112, in some implementations, is conducted within a cloud-based processing environment, such as within a processor facility 118 and/or a storage facility 120.

In operation, the CSIS 112 obtains an order for a medical sequencing test via an order management engine 122. In some implementations, the order is entered from within the sequencing laboratory system 102. The order, in some implementations, is forwarded through the facility interface engine 110 from a separate component of the medical facility system 100, such as the pathology system 106. The order may include one or both of a sample identifier (e.g., as recorded by the pathology system 106 in a sample data repository 124) and a patient identifier (e.g., as recorded by the records system 104 in an electronic medical record repository 126). The order, in some implementations, includes data regarding a patient (e.g., as identified by the patient identifier). The patient data may be obtained from the registration system 108, where it is recorded in a patient data repository 128. In some implementations, the patient data includes admissions, discharge transfer (ADT) data. The order, in some examples, may include one or more of a tumor site, a histology report, one or more test panels to be run, a deadline, a priority, and an operator identifier (e.g., unique identifier corresponding to one or more of the issuer of the request, a supervising clinician, a pathologist, a surgeon, a doctor, or another medical facility professional).

Using the order information (e.g., the sample identifier and/or the patient identifier), the order management engine 122, in some implementations, links the order to a biological sample available to the sequencing laboratory system 102. For example, a tumor biopsy, obtained in pathology (e.g., and entered into the sample data repository 124 of the pathology system 106) may be physically provided to personnel of the sequencing laboratory system 102 (e.g., to a wet lab portion of the sequencing laboratory system 102 tasked with preparing the biological sample for insertion into high throughput sequencing apparatus). The order management engine 122 may update a status of the order based upon the outcome of linking the sample to the order (e.g., sample delivered, sample unavailable, etc.).

In some implementations, the order management engine 122 verifies that the order is valid (e.g., submitted by authorized personnel). For example, the order management engine 122 may provide the operator identifier to an access management engine 130 to verify that the sequencing test has been ordered by an authorized operator. At various stages during the processing of the order, the order management engine 122 may relay information regarding the order through the facility interface engine (e.g., to the records system 104). For example, upon verification of the order information, the order management engine 122 may update the order status to “accepted” or “pending” and alert the medical facility system 100 of the present status.

In some implementations, the order management engine 122 provides information to a workflow management engine 132 for scheduling the order within the sequencing laboratory system 102. The workflow management engine 132 establishes a workflow including a combination of stages such as, in some examples, laboratory accessioning and sample preparation, sequencer processing, post-sequencing analysis processing, and report generation. In some implementations, the workflow management engine 132 coordinates two or more orders and may preempt one order for the new order based, for example, upon a priority and/or deadline associated with each of the pending orders. An example workflow is described below in relation to FIG. 2. Information pertaining to the workflow may be stored, for example, in an operational data repository 138.

As steps of the workflow are completed, in some implementations, an audit management engine 134 logs information to an audit trail. The audit trail, in some examples, may be associated with one or more of an order identifier, a biological sample identifier, and a patient identifier. The audit trail, for example, may be stored within an audit data repository 126 accessible to the CSIS 112. Additionally, as steps of the workflow are completed, the order management engine 122, in some implementations, may provide updates regarding the order status (e.g., via the facility interface engine 110 to one or more of an ordering system affiliated with the order and the records system 104).

As the workflow progresses, the prepared biological sample is sequenced by the sequencer apparatus 114. The sequencer apparatus 114 may apply one or more sequencing methods to the biological sample such as, in some examples, single-molecule real-time sequencing, Ion Torrent sequencing, pyrosequencing, 454 pyrosequencing, Solexa sequencing, sequencing by synthesis, sequencing by ligation, Polony sequencing, Sanger sequencing, nanoball sequencing, nanopore DNA sequencing, sequencing by hybridization, mass spectrometry sequencing, polymerase sequencing, RNA polymerase (RNAP) sequencing, microscopy-based sequencing, and in vitro virus sequencing. The sequencer apparatus 114, in some examples, can include a massively parallel signature sequencing apparatus, a Polony sequencing apparatus, a pyrosequencing apparatus, a 454 pyrosequencing apparatus, a Solexa sequencing apparatus, a ligation sequencing apparatus, an ion semiconductor sequencing apparatus, a nanoball sequencing apparatus, a single molecule real time (SMRT) sequencing apparatus, a nanopore DNA sequencing apparatus, a sequencing by hybridization apparatus, a mass spectrometry sequencing apparatus, a microfluidic Sanger sequencing apparatus, a polymerase sequencing apparatus, an RNA polymerase (RNAP) sequencing apparatus, a microscopy-based sequencing apparatus, or an in vitro virus sequencing apparatus.

While performing the sequencing, the sequencer produces raw data 114. In some implementations, a data archive manager 140 may retain the raw data 114 output by the sequencing apparatus 114. For example, the raw data 114 may be retained, for archival purposes, in a retention data repository 142, accessible to the CSIS 112. The retention data repository 142, in some examples, may be part of the sequencing laboratory system 102, accessible to the sequencing laboratory system 102 within the medical facility system 100 (e.g., stored in a data bank resident upon the medical facility campus), or uploaded to a network (e.g., cloud-based) storage facility such as the storage facility 120. In some implementations, the data archive manager 140 enters the raw data 114 into a data warehouse system for future data mining and research purposes. One or more security algorithms may be applied to the raw data 114 such that access to the stored raw data 114 is restricted. For example, the raw data 114 may be encrypted. In some implementations, the security algorithm(s) applied to the raw data 114 are in compliance with patient privacy guidelines, such as the Health Insurance Portability and Accountability Act of 1996 (HIPAA) guidelines.

Upon obtaining the raw data 116, in some implementations, the workflow management engine 132 schedules sequence analysis. A sequence analysis engine 144, in some implementations, analyzes the raw data 116 in view of one or more references 146. The analysis, in some implementations, results in aligned data (e.g., aligned in view of one or more of the references 146). The references 146 may include biological structure information and/or biological sequence information. In some examples, references 146 may include one or more of a genome, a microRNAome, a ncRNAome, a transcriptome, a proteome, an epigenome and a metabolome. In some implementations, analysis of the raw data 116 results in identification of one or more differences between the aligned data and the one or more references 146. In some implementations, the sequence analysis engine 144 analyzes the raw data with respect to one or more identified genes, one or more identified single nucleotide polymorphisms, and/or one or more mutations. For example, the one or more differences include one or more differences with regarding to the identified genes, nucleotide polymorphisms, and/or mutations.

Prior to aligning the raw data 116, in some implementations, raw data 116 may be converted to a standard format. For example, the sequence analysis engine 144 may be designed to manipulate a particular data type (e.g., file format type). In the circumstance that one or more sequencers included in the sequencing laboratory system 102 output raw data in a format different than the format anticipated by the sequence analysis engine 144, the CSIS 112 (e.g., coordinated by the workflow management engine 132) may convert the raw data 116 into a standardized format. The standardized format, in some implementations, is a FASTQ format.

In some implementations, the sequence analysis engine 144 identifies one or more processing algorithms to apply to the raw data 116. For example, based upon one or more of a tissue sample type, tumor site of interest, and/or test panels requested, the sequence analysis engine 144 may adjust processing of the raw data 116. In another example, the type of processing applied to the raw data 116 may be based at least in part upon the type of sequencing apparatus used. For example, different processing may be applied in relation to raw data obtained via polymerase sequencing than is applied to raw data obtained via Sanger sequencing.

In some implementations, the sequence analysis engine 144 identifies a processing algorithm for identifying one or more treatment regimens based upon the aligned data. For example, based at least in part upon identified differences, the sequence analysis engine 144 may determine one or more therapies, combinations of therapies, medications, and/or dosing schedules. In other implementations, analysis in light of treatment regimens occurs at time of report generation (e.g., coordinated by a report preparation engine 150). In some implementations, the sequence analysis engine 144 applies one or more rule sets to the aligned data to identify one or more treatment regimens correlated to the identified differences. The rule sets, for example, may include one or more mutations, one or more SNPs, and/or one or more polymorphisms.

The sequence analysis engine 144, in some implementations, may coordinate parallel processing of the analysis of the raw data 116, for example to increase speed of analysis. In some implementations, the sequence analysis engine 144 coordinates the parallel processing of raw data obtained from two or more sequencing tests. For example, each test of two or more sequencing tests may be analyzed using one or more available processors from a number of available processors. In some implementations, a network-based processing facility within the medical facility system 100 (e.g., provided by computing apparatus maintained upon the medical facility campus), or uploaded to a network (e.g., cloud-based) processing facility such as the processor facility 118.

In some implementations, analysis of the raw data 116 results in aligned data including one or more of an alignment data file (e.g., a Sequence Alignment/Map (SAM) file, a Binary SAM (BAM) file, a Gap4 file, etc.), a difference file (e.g., a Variant Call Format (VCF) file, a Genome Variation Format (GFV) file, etc.) and one or more log files including an audit trail of processing stages and/or results.

In some implementations, the audit management engine 134 retains audit data regarding the processing of the raw data. For example, the audit management engine 134 may collect information regarding file size, file storage location, and one or more timestamps related to the processing of the raw data 116.

In some implementations, the data archive management engine 140 may store the aligned data. For example, the aligned data may be retained, for archival purposes, in an analysis data repository 148, accessible to the CSIS 112. The analysis data repository 148, in some examples, may be part of the sequencing laboratory system 102, accessible to the sequencing laboratory system 102 within the medical facility system 100 (e.g., stored in a data bank resident upon the medical facility campus), or uploaded to a network (e.g., cloud-based) storage facility such as the storage facility 120. In some implementations, the data archive manager 140 enters the aligned data into a data warehouse system for future data mining and research purposes. One or more security algorithms may be applied to the analysis data 148 such that access to the analysis data 148 is restricted. For example, the analysis data 148 may be encrypted. In some implementations, the security algorithm(s) applied to the analysis data 148 are in compliance with patient privacy guidelines, such as the Health Insurance Portability and Accountability Act of 1996 (HIPAA) guidelines.

In some implementations, after the aligned data has been generated, a medical professional such as a pathologist may be provided the opportunity to annotate or adjust the information contained within the aligned data. For example, using an sequence data viewing software tool such as, in some examples, BamView by the Pathogen Group at the Sanger Institute, the Integrative Genomics Viewer by the Broad Institute, Bambino by Michael Edmonson, or GenoViewer by Astrid Research, Inc., a pathologist may annotate the aligned data. In some implementations, the access management engine 130 protects access to the aligned data, for example to a particular professional team (e.g., pathologists, etc.) or a particular group of people (e.g., one or more members of the medical facility staff having clearance to review and/or modify the aligned data). The CSIS 112, in some implementations, includes a sequence data viewer (not illustrated) for viewing the aligned data. If annotations are added to the aligned data, in some implementations, the data archive management engine 140 archives the data in the retention data repository 142.

In some implementations, after the aligned data is available, one or more reports are generated in relation to the data. The report preparation engine 150, for example, may be configured to generate report data identifying test results related to analysis of the aligned data. The report data, in some examples, may include a date of testing, a method of test performance (e.g., type of sequencing apparatus used, etc.), one or more test panels identified within the order, a listing of one or more differences identified between the raw data and the reference(s), a diagnostic interpretation, histology information, tumor site information, laboratory notes added by a technician (e.g., during preparation of the biological sample in the wet lab), annotations included by a pathologist or other authorized medical personnel, and/or demographic data regarding the patient associated with the order.

In some implementations, the report data includes additional medical record information regarding the patient such as, in some examples, information gleaned from the pathology system 106 (e.g., imaging data, pathologist case notes, etc.), information obtained from a radiology system, or information obtained from a cardiology system. Examples of various systems that may be in communication with the sequencing laboratory system 102 are illustrated in FIG. 3. The CSIS 112, for example, may access information from external systems of the medical facility system 100 via the facility interface engine 110, and merge accrued data into the report.

In some implementations, the report data includes one or more suggested treatment regimens such as, in some examples, a therapy, combination of therapies, medication, and/or dosing schedule. In some implementations, the report data includes one or more clinical trials available to the patient based in part upon information identified within the test results. For example, a note within a report may identify a clinical trial and provide contact information for obtaining further information (e.g., a clinical trial coordinator, etc.).

The report data, in some implementations, may be formatted based in part upon a target audience. For example, a first report style may be presented for review by a pathologist (e.g., a pathology report), while a second report style may be presented for review by a referring clinician (e.g., a clinician report, diagnostic report).

In some implementations, report data is generated as part of the workflow process. For example, upon determining that the sequence analysis engine 144 has completed the processing of the raw data, the workflow management engine 132 may initiate report generation. In another workflow example, upon sign-off by a pathology (e.g., after viewing the analysis data 148 using a sequence viewing tool and, optionally, annotating the results), the workflow management engine 132 may initiate generation of report data with the report preparation engine 150.

In some implementations, report data is generated on behalf of a requestor, such as a pathologist or other medical professional. Upon accessing the CSIS 112 to review report information, in some implementations, the audit management engine 134 determines whether the operator has clearance to order and/or review report data. The report data, for example, may be secured such that only those users of a particular access level are allowed to review the report data.

In some implementations, the data archive manager 140 may retain the report data generated by the report preparation engine 150. For example, the report data may be retained, for archival purposes, in a report data repository 152, accessible to the CSIS 112. The report data repository 152, in some examples, may be part of the sequencing laboratory system 102, accessible to the sequencing laboratory system 102 within the medical facility system 100 (e.g., stored in a data bank resident upon the medical facility campus), or uploaded to a network (e.g., cloud-based) storage facility such as the storage facility 120. One or more security algorithms may be applied to the report data 152 such that access to the report data 152 is restricted. For example, the report data 152 may be encrypted. In some implementations, the security algorithm(s) applied to the report data 152 are in compliance with patient privacy guidelines, such as the Health Insurance Portability and Accountability Act of 1996 (HIPAA) guidelines.

In some implementations, at least a portion of the report data 152 is provided to the records system 104 for inclusion in the electronic medical record 126 associated with the patient identifier. The portion of the report data 152, for example, may be issued to the records system 104 via the facility interface engine 110 within an HL7 message by the order management engine 122 (e.g., at point of order completion. In some implementations, rather than providing report data 152, a logical link to the report data 152, such as a uniform resource identifier (URI), is provided to the records system 104. The URI, for example, may navigate a user, upon selection, to a storage location within the sequencing lab system 102 where the report data is available for access. Access to the report data stored at the logical link location, in some implementations, is restricted, for example based upon user authorization level. For example, the access management engine 130 may restrict access to the URI based upon provided user credentials (e.g., submitted in a hypertext transfer protocol (HTTP) request, etc.).

Upon completion of the order (e.g., at the end point of the workflow established by the workflow management engine 132), in some implementations, the order management engine 122 issues an update regarding the order via the facility interface engine 110 to one or both of the ordering system (e.g., the pathology system 106) and the records system 104.

Turning to FIG. 2, a flow diagram illustrates an example workflow 200 for processing an order in a sequencing laboratory system, such as the sequence laboratory system 102 of FIG. 1. The workflow 200, for example, may be coordinated by the workflow management engine 132.

In some implementations, the workflow 200 begins with identifying receipt of a biological sample 202 (210). The biological sample 202 (e.g., blood sample, urine sample, tissue biopsy, etc.), for example, may be delivered to the sequencing laboratory system (e.g., into a wet lab) from a pathology lab (e.g., part of the pathology system 106 of FIG. 1). In some implementations, a technician within the wet lab of the sequencing laboratory system enters receipt of the biological sample 202 (e.g., based upon one or more of a sample identifier and a patient identifier). A machine readable code portion of the biological sample (e.g., a bar code printed to the slide, etc.), in some implementations, is scanned to enter the biological sample into the system. The machine readable code may have been applied from an external system (e.g., the pathology system 106) or internally, for example upon preparation of a slide including the biological sample. Upon recognizing that the biological sample 202 has been received, in some implementations, the stage of the workflow (e.g., “sample available”) is entered as audit data 136. In some implementations, based upon acknowledgement of availability of the biological sample 202, the workflow management engine 132 coordinates preparation of a sequencing sample 204 (e.g., DNA-extracted sample, etc., to provide to sequencing apparatus).

In some implementations, preparation of the sequencing sample 204 is identified (212). For example, upon preparing the sequencing sample 204, a technician may log into the system the availability of the sequencing sample 204 for analysis. In some implementations, logging the sequencing sample 204 as available includes scanning a machine-readable code applied to the sequencing sample (e.g., a barcode applied to the sample container, etc.). Upon recognizing that the sequencing sample 204 has been prepared, in some implementations, the stage of the workflow (e.g., sequencing sample prepared) is entered as audit data 136.

In some implementations, based upon acknowledgement of availability of the sequencing sample 204, sequencing is scheduled (214). For example, the workflow management engine 132 may identify the high throughput sequencer 114 for sequencing the sequencing sample 204 and queue the sequencing sample 204 for sequencing. After the schedule has been determined, in some implementations, the stage of the workflow (e.g., sequencing scheduled) is entered as audit data 136. Upon identification of availability of the high throughput sequencer 114 for the sequencing sample 204 (e.g., a previously scheduled sequencing sample has been sequenced), in some implementations, the workflow management engine 132 may alert laboratory personnel to load the sequencing sample 204 in the high throughput sequencer 114. Additionally, in some implementations, the status of the workflow may be updated in the audit data 136 to a status of, e.g., “sequencing”.

In some implementations, raw data 116 is identified as being available (216). Upon completion of sequencing with the sequencing apparatus 114, for example, the raw data 116 may be added to retention data 142 (e.g., by the data archive management engine 140 of FIG. 1).

The workflow management engine 132, upon identifying availability of the raw data 116, in some implementations, schedules processing of the raw data 116 (218). For example, the workflow management engine 132 may schedule alignment of the raw data 116 with the sequence analysis engine 144 based upon one or more references 146 (described in relation to FIG. 1). If the raw data 116 is not in a format suitable for alignment processing, in some implementations, the workflow management engine 132 may first schedule reformatting of the raw data 116. In some implementations, the status of the workflow may be updated in the audit data 136 to a status of, e.g., “analyzing” (or “reformatting”, if applicable).

In some implementations, availability of aligned data 148 is recognized (220). In some implementations, the aligned data 148 is archived as retention data 142, for example by the data archive management engine 140 of FIG. 1. The workflow management engine 132, in some implementations, issues an alert to one or more operators of the sequencing laboratory system 102 and/or another medical professional in the medical facility (e.g., pathologist, etc.) for review, verification, and potential annotation of the aligned data 148. For example, a personnel member may review the aligned data 148 using a sequence viewing software tool. In some implementations, the workflow management engine 132 receives an indication of acceptance of the aligned data 148 and updates the status of the order (e.g., via the order management engine 122 of FIG. 1) accordingly.

In some implementations, report preparation is scheduled (222). A report of the aligned data 148 may be scheduled with the report preparation engine 152 based upon availability of the aligned data 148, the indication of acceptance of the aligned data 148 by an authorized operator of the sequencing laboratory system, and/or identification of a request by an authorized operator of the sequencing laboratory system for report generation. In some implementations, scheduling of report preparation includes an indication of a type of report (e.g., pathology report, clinician report, etc.). In some implementations, the status of the workflow may be updated in the audit data 136 to a status of, e.g., “reporting”.

In some implementations, availability of report data 152 is identified (224). In some implementations, the report data 152 is archived, for example by the data archive management engine 140 of FIG. 1. A report 208, in some implementations, is issued to the records system 104 of the medical facility system 100 (described in relation to FIG. 1), for addition to the electronic medical record 126 associated with the patient identifier. In some implementations, rather than providing report 208, a logical link to the report 208, such as a uniform resource identifier (URI), is provided to the records system 104. The URI, for example, may navigate a user, upon selection, to a storage location within the sequencing lab system 102 where the report 208 is available for access. Access to the URI, in some implementations, is restricted, for example based upon user authorization level.

In some implementations, the report 208 is printed, faxed, emailed, and/or presented to an operator of the sequencing laboratory system 102 (e.g., upon a display device). In some implementations, the workflow 200 is completed (e.g., the audit trail may be closed within the audit data 136).

At the various stages of the workflow, in some implementations, the workflow management system 132 updates the order management system 122 with current status information. For example, where the audit data 136 is identified as being updated, the order management system may additionally update the status of the order, for example by issuing an HL7 message via the facility interface engine 110 to the records system 104, as illustrated in relation to FIG. 1. The order status, for example, may be modified to a “completed” status upon completion of the workflow 200.

FIG. 3 is a block diagram of an example medical facility system 300 and example communications integration via the central facility interface 110. The example medical facility system includes the sequencing laboratory system 102, a nuclear medicine system 302, a mammography system 304, a laboratory clinical system 306, an endoscopy system 308, the records system 104, the pathology system 106, a pharmacy system 310, a radiology system 312, a billing system 314, and a cardiology system 316. The various systems included in the example medical facility system 300, other than the billing system 314 and the records system 104, each communicate order and result information via the facility interface engine 110. For example, a sequencing laboratory system order may be communicated to the sequencing laboratory system 102 from the pathology system 106 via the facility interface engine 110. Each of these systems receives patient data, for example in the form of admissions, discharge transfer (ADT) data, as entered via a registration system (not illustrated, e.g., the registration system 108 of FIG. 1). The various systems, in some implementations, communicate through HL7 formatted messages.

The sequencing laboratory system 102, in some implementations, receives ADT data 318 (e.g., from the records system 104 or a registration system), receives a sequencing order 320 associated with ADT data, exports sequencing results 320 upon completion of the order, exports clinical report information 322 upon completion of the order (e.g., for attaching to an electronic medical record in the records system 104 or for review by a member of the pathology system 106), and exports billing codes 324 related to the fulfillment of the order for the billing system 314. In some implementations, the sequencing laboratory system 102 retrieves information from one or more of the systems 302, 304, 306, 308, 106, 312, and 316 for inclusion in the clinical report and/or to contribute to analysis of the sequencing data related to the order. In some implementations, during processing of the order, the sequencing laboratory system communicates order status updates 320 to the records system 104 via the facility interface engine 110.

The medical facility system 300 is a small, simplified version of an actual hospital computing system environment. In an actual medical facility deployment, tens if not hundreds of systems may intercommunicate via the facility interface engine 110. Additionally, each of the systems listed may communicate additional forms of information and/or receive different types of messages than those portrayed in FIG. 3.

FIG. 4 is a flow diagram 400 of example workflow stages for processing orders in a sequencing laboratory system, such as the sequencing laboratory system 102 of FIG. 1. With each workflow stage, corresponding data is collected and stored. The data, for example, includes both operational data 138 and retention data 142, as described in relation to FIG. 1. The stages of the workflow, in some implementations, are coordinated by the workflow management engine 132, as described in relation to FIG. 1.

Turning to a first workflow stage 402, accessioning, in some implementations, includes receipt and barcoding of the biological sample. Accessioning, for example, is described in relation to workflow management step 210 of FIG. 2. Registered sample data 414, in some implementations, is collected and stored within the operational data repository 138 during the accessioning workflow stage 402.

In a second (wet lab) workflow stage 404, a wet lab management workflow, in some implementations, is coordinated by the workflow management engine 132 to manage the preparation of the sequencing sample 204, described in relation to workflow management step 210 of FIG. 2. Sequencing sample information 416 (e.g., sample identifier, sample quantity, sample contents, etc.), instrument log data (e.g., instrument maintenance, calibration, correlation, and quality control logs, etc.), and/or workflow output data 420 (e.g., such as audit data 136), in some implementations, is collected and stored within the operational data repository 138.

In a third (sequencing) workflow stage 406, the sequencer apparatus 114 (described in relation to FIG. 1), in some implementations, sequences the sequencing sample 210 against one or more references and generates raw data 116 (e.g., FASTQ data). Management of the workflow stage 406, for example, is described in relation to step 212 of FIG. 2. Copies of the raw data, in some implementations, are stored in both the operational data repository 138 and the retention data repository 142.

In a fourth (processing) workflow stage 408, the processor facility 118 conducts sequence analysis (e.g., as determined by the sequence analysis engine 144) upon the raw data 116. Management of the workflow stage 406, for example, is described in relation to step 218 of FIG. 2. The processing workflow stage 408 results in analysis data (e.g., analysis data 148 as described in relation to FIG. 1) include aligned data (e.g., BAM file) 422, differences data (e.g., VCF file) 424, and log data (e.g., audit data 136) 426. Copies of the aligned data 422, differences data 424, and log data 426, in some implementations, are stored in both the operational data repository 138 and the retention data repository 142.

In a fifth (analysis) workflow stage 410, an operator of the sequencing laboratory system, such as a pathologist, reviews the aligned data 422 and differences data 424 using a sequence viewing software tool 428 (e.g., BAM viewer). The operator, in some implementations, provides annotations 430 to the aligned data. The annotations 430, in some implementations, are stored in both the operational data repository 138 and the retention data repository 142.

In a last (reporting & billing) workflow stage 412, the report preparation engine 150 generates report data based upon the aligned data 422, differences data 424, and annotations data 430. Management of the workflow stage 412, for example, is described in relation to step 222 of FIG. 2. Report preparation results in report data 152. Copies of the report data, in some implementations, are stored in the operational data repository 138 and the retention data repository 142. In some implementations, at least a portion of the report data 152 is issued to the records system 104 for association with the patient medical record. Additionally, in some implementations, mutation call data 432 (e.g., based upon the differences data 424) is stored in the retention data repository 142.

In some implementations, during the reporting & billing workflow stage 412, billing fee codes 434 are issued to the billing system 314. For example, as described in relation to FIG. 3, the sequencing laboratory system 102 may issue an HL7 message including billing codes 324 via the facility interface engine 110 to the billing system 314. The billing codes, in some implementations, correspond to one or more test panels associated with the order.

FIG. 5 is a process diagram of an example sequencing laboratory system process flow 500 following an example workflow associated with an order for sequencing of a biological sample with the sequencing laboratory system 102. Order processing involves a number of operators 502 such as, in some examples, an escort representative 502a who is responsible for the delivery of the biological sample into the sequencing laboratory system 102 (e.g., from the pathology laboratory or another medical facility system involved in sample obtainment), one or more technologists 502b who handle the accessioning of the biological sample and preparation of the sequencing sample, one or more pathologists authorized in one or more sample preparation steps, such as microdissection of a biological sample, as well as the analysis, interpretation, and reporting aspects of the order processing, and one or more laboratory assistants 502d involved in error response and correction in the preparation of the biological sample. Each group of operators (e.g., the escort representative(s) 502a, the technologist(s) 502b, the pathologist(s) 502c, and the laboratory assistant 502d), in some implementations, represent levels of authorization within the sequencing laboratory system 102. For example, the escort representative 502a may be provided the lowest level of authorization for accessing the sequencing laboratory system 102 (e.g., input of particular type(s) of information, but no authority to view stored data related to an order), while the pathologist(s) 502c may be provided the highest level of authorization for accessing the sequencing laboratory system 102 (e.g., review, annotation, and manipulation of analysis data, report validation, etc.). in some implementations, the access management engine 130, described in relation to FIG. 1, validates access to the sequencing laboratory system 102 by the operators 502. The operators 502, in some examples, may enter access validation information by scanning a security badge or access card and/or by entering identification information (e.g., userid, password, biometric information, etc.).

In some implementations, the process flow 500 begins (504) with registration of the delivery of a biological specimen (e.g., sample) (506). Based upon evaluation (506a) of information entered by the escort representative 502a (e.g., scanning of a bar code included with the biological specimen, entry of information into a user interface presented by the order management engine 122, etc.), in some implementations, the process 500 branches to either a lab accessioning workflow 510 or a laboratory assistant accessioning workflow 512. The accessioning workflow, for example, includes the activities described in relation to the accession stage 402 of FIG. 4. The laboratory assistant 502d accessions the biological sample (e.g., tissue sample) for laboratory analysis.

Upon branching to the laboratory assistant accessioning workflow 512, for example, the laboratory assistant 502d accessions the biological sample and logs information regarding the sample into the laboratory sequencing system 102. At this point, for example, the biological sample may be assigned a unique identifier. After accessioning by the laboratory assistant 502d, the sample is transferred to a pathologist 502c for biologic preparation and/or microdissection 514 of the biological sample. Upon completion of the biologic preparation and/or microdissection 514 task(s), in some implementations, a message 516a is issued to the sequencing laboratory system 102. In some implementations, the message 516a (e.g., an entry into the order system via the order management engine 122) alerts the workflow management engine 132 to the availability of the prepared biological sample. Responsive to the message 516a, the workflow management engine 132, for example, may transition the status of the workflow (and, optionally, log information in an audit trail). In some implementations, responsive to the message 516a, the sequencing laboratory system 102 issues a message to the CSIS 112 regarding readiness of the biological sample for sequencing scheduling. The CSIS 112, in some implementations, enters an order processing workflow 550 (e.g., coordinated by the workflow management engine 132).

If, instead, the evaluation 506a of the registration of the specimen delivery 506 determines that the biological sample should be directed to the lab accessioning workflow 510, in some implementations, a technologist 502b is tasked with accessioning the biological sample. The tasks assigned to the technologist 502b, for example, are identified as the wet lab stage 404, described in relation to FIG. 4. Based upon an evaluation 510a of information submitted by the technologist 502b (e.g., whether there is a problem with the biological sample), in some implementations, the process flow 500 branches to a handle rejected sample workflow 520. As part of the handle rejected sample workflow 520, a message 516b is issued to the sequencing laboratory system 102. In some implementations, the message 516b (e.g., order cancelled/suspended due to rejected sample) alerts the workflow management engine 132 to the termination of the workflow 500. The workflow management engine 132, in some implementations, issues an alert to an external system, such as the pathology system 106 (e.g., the system which provided the biological sample) regarding the problem with the rejected biological sample.

Returning to the evaluation 506a of the registration of the specimen delivery 506, upon determination of success, the process flow 500 instructs the technologist 502b to pick up the biological specimen and prepare a sequencing sample 522. For example, the biological sample may be prepped for DNA extraction 524. An evaluation 524 of the DNA extraction 524, upon determination of failure, branches to a handle extraction fail workflow 526. If instead, upon the evaluation 524a of success of the DNA extraction workflow 524, the technologist enters a library preparation stage 528 involving quantification of the sequencing sample (e.g., DNA extraction). For example, the amount of DNA may be measured using a quantification method such as digital Polymerase Chain Reaction (PCR), standard curve method, or comparative C_{T} method.

Upon evaluation 528a of failure of the library preparation stage 528 (e.g., not a large enough DNA sample for sequencing), the process flow 500 branches to a handle quantification fail workflow 530. If instead, the library preparation evaluation 528a determines success, the process flow 500 transitions to a capture stage 532 for capturing the prepared sequencing sample (e.g., with the sequencer apparatus).

Upon completion of the capture stage 523, the process flow 500 transitions to a sequencing stage 534, where sequencing of the sequencing sample is conducted. The sequencing stage 534, for example, may correspond to the sequencing stage 406 described in relation to FIG. 4. An output of the sequencing stage 534 (e.g., raw data 116), in some implementations is stored in a storage medium 536 (e.g., “instrument storage” included in or in communication with the sequencer apparatus). In some implementations, upon completion of sequencing, the sequencer apparatus issues a message to the CSIS 112 regarding availability of the raw data 116. The CSIS 112, in some implementations, enters a data archiving workflow 552 (e.g., coordinated by the data archive management engine 140 of FIG. 1).

The output of the sequencing stage (e.g. raw data 116), in some implementations, is accessed from the instrument storage 536 by the processing facility 118, and a sequence processing workflow 538 is executed. The sequence processing workflow 538, for example, may correspond to the processing stage 408 described in relation to FIG. 4. In some implementations, the sequence processing workflow 538 is coordinated by the sequence analysis engine 144, described in relation to FIG. 1. Output of the sequence processing workflow 538 (e.g., aligned data, differences (variants), and/or log data), in some implementations, is stored within an operational storage 540.

Upon completion of the process sequencing stage 538, the process flow 500, in some implementations, enters an analysis and interpretation stage 542, assigned to the pathologist 502c. For example, the pathologist 502c may review data stored within the operational storage 540, add annotations to the data, and perform other operations described in relation to the analysis stage 410 of FIG. 4.

Upon completion of the analysis and interpretation stage 540 (e.g., upon validation of the data captured during the sequence processing stage 538), in some implementations, the process flow 500 enters a reporting stage 546, also assigned to the pathologist 502c. The reporting stage 546, for example, may include the operations described in relation to the reporting & billing stage 412 of FIG. 4. In some implementations, upon completion of the reporting & billing stage 412 (e.g., upon availability of report data 152 as described in relation to FIG. 1), the report & billing workflow 546 issues a message 548c to the CSIS 112 regarding availability of the report data 152. In some implementations, the CSIS 112 begins a report processing workflow 554 (e.g., coordinated by the workflow management engine 132). The report processing workflow 554, for example, may coordinate the transfer of report data to long term storage (e.g., via the data archive management engine 140 of FIG. 1) and/or the transfer of report data 152 to the records system 104 of FIG. 1 (e.g., for addition to the electronic medical record 126 of the associated patient). Upon completion of the back end processing by the CSIS, in some implementations, a message 516c is issued to the sequencing laboratory system 102. The message, for example, may cause the CSIS 112 to instruct the audit management engine 134 of FIG. 1 to finalize the audit data 136 associated with the order. Additionally, in some implementations, the CSIS 112 instructs the order management engine 122 of FIG. 1 to update the order status (e.g., to “completed”) with the records system 104.

FIG. 6 is a flow chart of an example method 600 for processing orders within an integrated sequencing laboratory system. The method 600, for example, may be performed within the sequencing laboratory system 102 of FIG. 1. In a particular example, the method 600 may be performed under coordination of the workflow management engine 132 of the CSIS 112, as described in relation to FIG. 1.

In some implementations, the method 600 begins with accessing an order including a request for analysis by high throughput sequencer apparatus (602). The order, for example, may be submitted via the facility interface engine 110 from a separate computing system of the medical facility system 100, as described in relation to FIG. 1. The order, in some implementations, is provided within an HL7 message including one or more of a patient identifier and a biological sample identifier. The order may include information regarding the request for analysis such as, in some examples, a tumor site, one or more test panels, a deadline, a priority, an operator who issued (opened) the order, and a histology.

In some implementations, the request for analysis is scheduled for processing with high throughput sequencer apparatus (604). The workflow management engine 132 of FIG. 1, for example, may schedule the request for processing with the sequencer 114, as described in relation to FIG. 1. If more than one high throughput sequencer is included within the sequencing laboratory system, in some implementations, particular high throughput sequencer apparatus may be identified. Identification may be based, for example, upon one or more of availability, pertinence to the type of test(s) (e.g., test panels) ordered, pertinence to the type of biological sample provided, scheduling constraints (e.g., speed of the various sequencer apparatus available), and analysis needs (e.g., richness of output of the data, etc.). Scheduling of processing with high throughput sequencer apparatus, for example, is described in relation to step 214 of FIG. 2 and workflow stage 406 of FIG. 4.

In some implementations, availability of result information including raw data generated by the high throughput sequencer apparatus is determined (606). The workflow management engine of FIG. 1, for example, may identify availability of raw data 116 output by the sequencer 114, as described in relation to FIG. 1. Determination of availability of result information, for example, is described in relation to step 216 of FIG. 2.

In some implementations, the raw data is assembled against one or more references into aligned data (608). The aligned data, for example, can include both aligned sequence data, variants (differences) between the raw data and the one or more references, and audit information (e.g., log information) regarding the assembly of the aligned data. The sequence analysis engine 144 of FIG. 1, for example, may coordinate processing of the raw data 116 with respect to one or more references 146. The references, in some examples, may include biological structure information and/or biological sequence information. In some examples, references 146 may include one or more of a genome, a microRNAome, a ncRNAome, a transcriptome, a proteome, an epigenome and a metabolome. Step 218 of the workflow of FIG. 2, for example, describes assembly of the raw data against one or more references.

In some implementations, the aligned data is analyzed with respect to information identified by the request for analysis (610). Analysis may include, for example, comparing one or more of the aligned data and the differences (e.g., variants) to one or more genes, one or more single nucleotide polymorphisms, and one or more mutations (e.g., as identified by the request for high throughput sequencing analysis). In some implementations, analyzing the data includes determining a treatment regimen for the patient associated with the order. For example, based at least in part upon identified differences, the sequence analysis engine 144 may determine one or more therapies, combinations of therapies, medications, and/or dosing schedules. The sequence analysis engine 144, described in relation to FIG. 1, may analyze the data with respect to information identified by the request for analysis. In another example, the report preparation engine 150 of FIG. 1 may analyze the data with respect to information identified by the request for analysis. In some implementations, analysis of aligned data corresponds to the workflow step 222 of FIG. 2 and/or the reporting & billing stage 412 described in relation to FIG. 4.

In some implementations, analysis includes input provided in annotations appended to the aligned data by an authorized operator of the sequencing laboratory system. For example, a pathologist may review the aligned data and annotate as deemed appropriate. Annotation, for example, is described in relation to workflow stage 410 of FIG. 4.

In some implementations, the raw data and/or the aligned data is provided for long term storage (612). Archiving of the sequencing data, for example, may be done to associate the data with the electronic medical record of the patient, similar to archiving x-ray images and other laboratory test information. In some implementations, sequencing data, such as the raw data and/or the aligned data, may be archived in a data warehouse for future research purposes. In some implementations, the data archive manager 140 of FIG. 1 coordinates archival of the sequencing data. As illustrated in relation to FIG. 4, data may be replicated to long term storage at each of the sequencing workflow stage 406, the processing workflow stage 408, and the analysis workflow stage 410. In some implementations, the data is stored with the medical facility system (e.g., within a data collection residing on a facility campus. The data, in some implementations, is upload to a network (e.g., cloud) storage facility, such as the storage facility 120 of FIG. 1. During storage of the data, the information may be secured using one or more security algorithms to protect the privacy of the patient. For example, the data may be encrypted for storage.

In some implementations, a report is formatted for review by a medical professional (614). The report, for example, may include a date of testing, a method of test performance (e.g., type of sequencing apparatus used, etc.), one or more test panels identified within the order, a listing of one or more differences identified between the raw data and the reference(s), a diagnostic interpretation, histology information, tumor site information, laboratory notes added by a technician (e.g., during preparation of the biological sample in the wet lab), annotations included by a pathologist or other authorized medical personnel, and/or demographic data regarding the patient associated with the order. In some implementations, the report data includes additional medical record information regarding the patient such as, in some examples, information gleaned from a separate system of the medical facility system. Examples of various systems that may be in communication with the sequencing laboratory system are illustrated in FIG. 3. In some implementations, the report data includes one or more suggested treatment regimens such as, in some examples, a therapy, combination of therapies, medication, and/or dosing schedule. In some implementations, the report data includes one or more clinical trials available to the patient based in part upon information identified within the test results. For example, a note within a report may identify a clinical trial and provide contact information for obtaining further information (e.g., a clinical trial coordinator, etc.). The report data, in some implementations, may be formatted based in part upon a target audience. For example, a first report style may be presented for review by a pathologist (e.g., a pathology report), while a second report style may be presented for review by a referring clinician (e.g., a clinician report, diagnostic report).

The report preparation engine 150 of FIG. 1, for example, may be configured to generate report data identifying test results related to analysis of the aligned data. Scheduling of report preparation is described in relation to step 222 of FIG. 2. Report generation, for example, is described in greater detail in relation to the reporting & billing workflow stage 412 of FIG. 4.

In some implementations, report data is provided to a separate medical computing device for association with the patient medical record (616). In some implementations, the order management engine 122 may provide report data to the records system 104 via the facility interface engine 110, as described in relation to FIG. 1. The report data, in some implementations, includes at least a portion of the items described in relation to step 614. In some implementations, the report data includes a logical link for accessing the report data described in relation to step 614. The logical link (e.g., URI, uniform resource locator (URL), etc.), for example, may navigate a user, upon selection, to a storage location within the sequencing laboratory system where the report data is available for access. Access to the report data stored at the logical link location, in some implementations, is restricted, for example based upon user authorization level. For example, the access management engine 130 may restrict access to the report data based upon provided user credentials (e.g., submitted in a hypertext transfer protocol (HTTP) request, etc.).

As shown in FIG. 7, an implementation of an exemplary cloud computing environment 700 for integrating sequencing apparatus and a sequencing laboratory system into a medical facility is shown and described. The cloud computing environment 700 may include one or more resource providers 702a, 702b, 702c (collectively, 702). Each resource provider 702 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 702 may be connected to any other resource provider 702 in the cloud computing environment 700. In some implementations, the resource providers 702 may be connected over a computer network 708. Each resource provider 702 may be connected to one or more computing device 704a, 704b, 704c (collectively, 704), over the computer network 708.

The cloud computing environment 700 may include a resource manager 706. The resource manager 706 may be connected to the resource providers 702 and the computing devices 704 over the computer network 708. In some implementations, the resource manager 706 may facilitate the provision of computing resources by one or more resource providers 702 to one or more computing devices 704. The resource manager 706 may receive a request for a computing resource from a particular computing device 704. The resource manager 706 may identify one or more resource providers 702 capable of providing the computing resource requested by the computing device 704. The resource manager 706 may select a resource provider 702 to provide the computing resource. The resource manager 706 may facilitate a connection between the resource provider 702 and a particular computing device 704. In some implementations, the resource manager 706 may establish a connection between a particular resource provider 702 and a particular computing device 704. In some implementations, the resource manager 706 may redirect a particular computing device 704 to a particular resource provider 702 with the requested computing resource.

FIG. 8 shows an example of a computing device 800 and a mobile computing device 850 that can be used to implement the techniques described in this disclosure. The computing device 800 is intended to represent various forms of digital computers, such as laptops, desktops, workstations, personal digital assistants, servers, blade servers, mainframes, and other appropriate computers. The mobile computing device 850 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 804 stores information within the computing device 800. In some implementations, the memory 804 is a volatile memory unit or units. In some implementations, the memory 804 is a non-volatile memory unit or units. The memory 804 may also be another form of computer-readable medium, such as a magnetic or optical disk.

The storage device 806 is capable of providing mass storage for the computing device 800. In some implementations, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 802), perform one or more methods, such as those described above. The instructions can also be stored by one or more storage devices such as computer- or machine-readable mediums (for example, the memory 804, the storage device 806, or memory on the processor 802).

The high-speed interface 808 manages bandwidth-intensive operations for the computing device 800, while the low-speed interface 812 manages lower bandwidth-intensive operations. Such allocation of functions is an example only. In some implementations, the high-speed interface 808 is coupled to the memory 804, the display 816 (e.g., through a graphics processor or accelerator), and to the high-speed expansion ports 810, which may accept various expansion cards (not shown). In the implementation, the low-speed interface 812 is coupled to the storage device 806 and the low-speed expansion port 814. The low-speed expansion port 814, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. In addition, it may be implemented in a personal computer such as a laptop computer 822. It may also be implemented as part of a rack server system 824. Alternatively, components from the computing device 800 may be combined with other components in a mobile device (not shown), such as a mobile computing device 850. Each of such devices may contain one or more of the computing device 800 and the mobile computing device 850, and an entire system may be made up of multiple computing devices communicating with each other.

The mobile computing device 850 includes a processor 852, a memory 864, an input/output device such as a display 854, a communication interface 866, and a transceiver 868, among other components. The mobile computing device 850 may also be provided with a storage device, such as a micro-drive or other device, to provide additional storage. Each of the processor 852, the memory 864, the display 854, the communication interface 866, and the transceiver 868, are interconnected using various buses, and several of the components may be mounted on a common motherboard or in other manners as appropriate.

The processor 852 can execute instructions within the mobile computing device 850, including instructions stored in the memory 864. The processor 852 may be implemented as a chipset of chips that include separate and multiple analog and digital processors. The processor 852 may provide, for example, for coordination of the other components of the mobile computing device 850, such as control of user interfaces, applications run by the mobile computing device 850, and wireless communication by the mobile computing device 850.

The processor 852 may communicate with a user through a control interface 858 and a display interface 856 coupled to the display 854. The display 854 may be, for example, a TFT (Thin-Film-Transistor Liquid Crystal Display) display or an OLED (Organic Light Emitting Diode) display, or other appropriate display technology. The display interface 856 may include appropriate circuitry for driving the display 854 to present graphical and other information to a user. The control interface 858 may receive commands from a user and convert them for submission to the processor 852. In addition, an external interface 862 may provide communication with the processor 852, so as to enable near area communication of the mobile computing device 850 with other devices. The external interface 862 may provide, for example, for wired communication in some implementations, or for wireless communication in other implementations, and multiple interfaces may also be used.

The memory 864 stores information within the mobile computing device 850. The memory 864 can be implemented as one or more of a computer-readable medium or media, a volatile memory unit or units, or a non-volatile memory unit or units. An expansion memory 874 may also be provided and connected to the mobile computing device 850 through an expansion interface 872, which may include, for example, a SIMM (Single In Line Memory Module) card interface. The expansion memory 874 may provide extra storage space for the mobile computing device 850, or may also store applications or other information for the mobile computing device 850. Specifically, the expansion memory 874 may include instructions to carry out or supplement the processes described above, and may include secure information also. Thus, for example, the expansion memory 874 may be provide as a security module for the mobile computing device 850, and may be programmed with instructions that permit secure use of the mobile computing device 850. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 852), perform one or more methods, such as those described above. The instructions can also be stored by one or more storage devices, such as one or more computer- or machine-readable mediums (for example, the memory 864, the expansion memory 874, or memory on the processor 852). In some implementations, the instructions can be received in a propagated signal, for example, over the transceiver 868 or the external interface 862.

The mobile computing device 850 may communicate wirelessly through the communication interface 866, which may include digital signal processing circuitry where necessary. The communication interface 866 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 868 using a radio-frequency. In addition, short-range communication may occur, such as using a Bluetooth®, Wi-Fi™, or other such transceiver (not shown). In addition, a GPS (Global Positioning System) receiver module 870 may provide additional navigation- and location-related wireless data to the mobile computing device 850, which may be used as appropriate by applications running on the mobile computing device 850.

The mobile computing device 850 may also communicate audibly using an audio codec 860, which may receive spoken information from a user and convert it to usable digital information. The audio codec 860 may likewise generate audible sound for a user, such as through a speaker, e.g., in a handset of the mobile computing device 850. Such sound may include sound from voice telephone calls, may include recorded sound (e.g., voice messages, music files, etc.) and may also include sound generated by applications operating on the mobile computing device 850.

The mobile computing device 850 may be implemented in a number of different forms, as shown in the figure. For example, it may be implemented as a cellular telephone 880. It may also be implemented as part of a smart-phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for integrating a sequencing apparatus and sequencing laboratory system into a medical facility are provided. Having described certain implementations of methods and apparatus for supporting integration of sequencing apparatus and sequencing laboratory system into a medical facility, it will now become apparent to one of skill in the art that other implementations incorporating the concepts of the disclosure may be used. Therefore, the disclosure should not be limited to certain implementations, but rather should be limited only by the spirit and scope of the following claims.

1. A method comprising:
accessing, by a processor of a computing device of a medical facility, an order comprising a request for analysis by high throughput sequencer apparatus, wherein the order is associated with a biological sample identifier and a patient identifier;
scheduling, by the processor, for processing with the high throughput sequencer apparatus, the request;
determining, by the processor, availability of result information responsive to the processing, wherein the result information comprises raw data generated by the high throughput sequencer apparatus;
assembling, by the processor, the raw data into aligned data, wherein assembling comprises aligning the raw data against one or more references;
analyzing the aligned data with respect to information identified by the request for analysis;
providing at least one of the raw data and the aligned data for long term storage;
formatting a report for review by a medical professional, wherein the report comprises information derived through analyzing the aligned data; and
providing, by the processor, information associated with the report to a separate medical facility computing device for association with the patient identifier.

2. The method of claim 1, wherein the order comprises an indication of at least one of a) a tumor site and b) one or more test panels.

3. The method of claim 1, wherein the one or more references comprises at least one of biological structure information and biological sequence information.

4-5. (canceled)

6. The method of claim 1, wherein the high throughput sequencer apparatus generates, by a processor of sequencer computing device, multiple, fragmented sequence reads.

7-9. (canceled)

10. The method of claim 1, comprising, after assembling the raw data, updating an order status regarding availability of the aligned data.

11. The method of claim 10, wherein updating the order status comprises issuing a message to a medical facility interface system.

12. (canceled)

13. The method of claim 1, wherein assembling the raw data comprises identifying differences between the raw data and the one or more references.

14. The method of claim 13, wherein the differences comprise at least one of a single nucleotide polymorphism (SNP) and a mutation.

15. (canceled)

16. The method of claim 1, wherein the assembling comprises:
accessing the one or more references stored in one or more target files;
accessing the raw data as a sequence file;
applying the one or more target files to the sequence file to generate the aligned data as an aligned sequence file;
generating a variant file comprising information regarding differences between the sequence file and the one or more target files; and
generating at least one log file comprising audit information regarding the assembly process.

17. The method of claim 1, comprising associating one or more annotations with the aligned data.

18. The method of claim 17, wherein the one or more annotations are entered by an operator via a sequence alignment data viewing tool.

19. (canceled)

20. The method of claim 17, wherein formatting the report comprises including information regarding the one or more annotations within the report.

21. (canceled)

22. The method of claim 1, wherein analyzing the aligned data comprises identifying one or more treatment regimens.

23. The method of claim 22, wherein the one or more treatment regimens comprise at least one of a therapy, a combination of therapies, a medication, and a dosing schedule.

24. The method of claim 22, wherein formatting the report comprises including, within the report, the one or more treatment regimens.

25. (canceled)

26. The method of claim 1, wherein the report comprises information for referring clinicians.

27. The method of claim 1, wherein the report comprises a diagnostic report.

28-29. (canceled)

30. The method of claim 1, comprising, after determining availability of the result information, issuing, to a billing system of the medical facility, a billing notification.

31. The method of claim 1, wherein providing at least one of the raw data and the aligned data for long term storage comprises entering information into a data warehouse system for future data mining for research purposes.

32. (canceled)

33. The method of claim 1, wherein providing the at least one of the raw data and the aligned data for long term storage comprises securing the at least one of the raw data and the aligned data.

34. (canceled)

35. The method of claim 1, wherein assembling the raw data into the aligned data comprises processing two or more portions of the raw data in parallel.

36. A sequencing laboratory system comprising:
a high throughput sequencer apparatus; and
a computing system comprising a processor and a memory having instructions stored thereon, wherein the instructions, when executed by the processor, cause the processor to:
access an order comprising a request for analysis by the high throughput sequencer apparatus, wherein the order is associated with a biological sample identifier;
schedule, for processing with the high throughput sequencer apparatus, the request;
determine availability of result information responsive to the processing, wherein the result information comprises raw data produced by the high throughput sequencer apparatus;
assemble the raw data into aligned data, wherein assembling comprises aligning the raw data with one or more references;
analyze the aligned data, wherein analyzing the aligned data generates result information identifying differences between the raw data and the one or more references;
responsive to completion of analyzing the aligned data, issue an alert to a medical facility registration system regarding completion of the order; and
provide at least one of the raw data and the aligned data for storage in a data archive.

37. The sequencing laboratory system of claim 36, wherein the instructions when executed cause the processor to, prior to scheduling the request, determine availability of a biological sample associated with the biological sample identifier.

38. The sequencing laboratory system of claim 36, wherein the instructions when executed cause the processor to archive information regarding at least one of assembling the raw data into aligned data and analyzing the aligned data.

39-42. (canceled)

43. The sequencing laboratory system of claim 36, comprising a second high throughput sequencer apparatus, wherein scheduling the request comprises identifying the high throughput sequencer apparatus for processing of the request.

44. The sequencing laboratory system of claim 43, wherein the high throughput sequencer apparatus is identified based at least in part upon one or more test panels associated with the request.

45. (canceled)

46. The sequencing laboratory system of claim 36, wherein scheduling the request comprises determining at least one of a priority level and a deadline associated with the request.

47. The sequencing laboratory system of claim 46, wherein scheduling the request comprises preempting, based at least in part on the at least one of the priority level and the deadline, a preexisting request.

48. A non-transitory computer readable medium having instructions stored thereon, wherein the instructions, when executed by a processor, cause the processor to:
receive, via a medical facility system, a request for analysis by a high throughput sequencer apparatus, wherein the request comprises a patient identifier;
determine registration of delivery of a biological sample associated with the patient identifier;
responsive to registration of delivery of the biological sample, schedule preparation of the biological sample for processing with the high throughput sequencer apparatus;
receive acknowledgement of completion of preparation of the biological sample;
responsive to the acknowledgement of completion of preparation of the biological sample, schedule, for processing with the high throughput sequencer apparatus, the request;
determine availability of result information responsive to the processing, wherein the result information comprises raw data produced by the high throughput sequencer apparatus;
analyze the result information to obtain analysis data;
responsive to completion of analysis, issue a notification to the medical facility system regarding completion of the request, wherein the notification comprises the patient identifier; and
store, for archival purposes, at least one of the raw data and the analysis data.

49. The computer readable medium of claim 48, wherein:
the biological sample comprises a tissue sample; and
the instructions, when executed, cause the processor to:
after scheduling the request, receive a failure indication associated with rejection of the biological sample;
issue, for review by an operator, responsive to the failure indication, a request for a replacement biological sample;
receive indication of availability of the replacement biological sample; and
reschedule, for processing with the high throughput sequencer apparatus, the request.

50. The computer readable medium of claim 49, wherein the indication of availability is provided by an operator, wherein the operator has an access level of one of a lab technologist access level and a pathologist access level.

51. The computer readable medium of claim 48, wherein the instructions, when executed, cause the processor to secure report information associated with the analysis data for presentation to operators having one or more authorized access levels.

52. The computer readable medium of claim 51, wherein the one or more authorized access levels comprises a pathologist access level.

53. The computer readable medium of claim 51, wherein the instructions, when executed, cause the processor to:
request user identification associated with the report information;
receive user identification information associated with an operator;
based at least in part upon the user identification information, verify authorization of the operator to review the report information; and
responsive to verification, provide the report information for review by the operator at a display device.

54. The computer readable medium of claim 51, wherein receiving user identification information comprises receiving information obtained from a personnel identification card.

55. The computer readable medium of claim 48, wherein receiving the request comprises receiving the request associated with an operator authorized to submit requests for analysis.

56. (canceled)
